(19) United States
(12) Patent Application Publication
(10) Pub. No.: US 2006/0175407 A1
(43) Pub. Date: Aug. 10, 2006

(54) RF-tag reading system and RF-tag reader/writer control system, and interference avoidance method therefor

(75) Inventor: Satoshi Kinoshita, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION

(21) Appl. No.: 11/345,269

(22) Filed: Feb. 2, 2006

(30) Foreign Application Priority Data
Feb. 9, 2005 (JP) 032407/2005

(51) Int. Cl. G06K 7/08; H04L 7/00

(52) U.S. Cl. 235/451; 340/825.21

(57) ABSTRACT

An RF-tag reading system is provided, in which a reading schedule for reading RF-tags, without interference among RF-tag readers/writers, can automatically be created. A schedule table is a table that stores the identifiers of RF-tag readers/writers to which schedule control should be applied; fields for storing the IDs of reference RF-tags are incorporated in the schedule table and utilized during creation of the schedule table. A schedule creation unit controls the RF-tag readers/writers to detect interference and then writes a reading schedule in the schedule table. A schedule control unit reads RF-tag information from the RF-tag readers/writers, while controlling timing in accordance with the contents of the schedule table.

### BACKGROUND OF THE INVENTION

1. Field of the Invention

The present invention relates to an RF-tag reading system, an RF-tag reader/writer control system, an RF-tag reader/writer interference avoidance method utilized in the systems, and a program for the method, and more particularly to avoidance of interference among query signals in the case where a plurality RF (Radio Frequency)-tag reader/writers concurrently implements wireless communication.

2. Related Art

By implementing wireless communication with an RF tag, an RF-tag reader/writer can read out an ID (Identifier: identification information) that the RF tag has. In this case, the RF-tag reader/writer sends a query signal to the RF tag that receives the query signal and then generates a response signal. The RF-tag reader/writer receives the response signal from the RF tag and identifies information of the RF tag.

However, in the case where a plurality of RF-tag reader/writers exists and respective antennas of the RF-tag reader/writers are close to others, respective query signals from the RF-tag reader/writers may interfere with others when the plurality of RF-tag reader/writers concurrently implements wireless communication, whereby information of the RF tag may not be read.

To date, as a method of avoiding the interference among the query signals, a first method has been utilized in which the timing of sending each of respective query signals from the RF-tag reader/writers is shifted from one another. In the first method, by controlling the timing of sending the query signal, control of a timing schedule is implemented so that two or more among a predetermined plurality of RF-tag reader/writers do not concurrently send the query signals.

In addition, as another method of avoiding the interference among the query signals, a second method has been disclosed in which, by providing a detection device for detecting signal interference from other reader/writers, signal communication is implemented in a condition in which no interference occurs (e.g., refer to Japanese Patent Laid-Open No. 10-293824 and No. 11-102419).

In the first method, it is necessary that whether or not RF-tag reader/writers cause the interference is ascertained, and if the interference occurs, a timing schedule for the RF-tag reader/writers is manually set.

Moreover, in the second method, a device for detecting signal interference should be provided in each RF-tag reader/writer or added to each existing RF-tag reader/writer.

In this regard, it is an object of the present invention to solve the foregoing problems and to provide an RF-tag reading system, an RF-tag reader/writer control system, an RF-tag reader/writer interference avoidance method utilized in the systems, and a program for the method with which, without interference among RF-tag reader/writers, a reading schedule for reading RF tags can automatically be created.

### BRIEF SUMMARY OF THE INVENTION

An RF (Radio Frequency)-tag reading system, according to the present invention, having an RF-tag reader/writer control system that, in the case where interference occurs among a plurality of RF-tag reader/writers for reading RF-tag identifiers of RF-tags, controls a schedule for the plurality of RF-tag reader/writers includes reading-test implementation means for making the RF-tag reader/writer control system implement a test of sequential reading, through the plurality of RF-tag reader/writers, of the RF-tag identifiers of reference RF-tags that are preliminarily installed prior to operation and an ascertainment device for ascertaining whether or not a single RF-tag can be read by the plurality of RF-tag reader/writers, based on the test of reading.

An RF (Radio Frequency)-tag reader/writer control system, according to the present invention, that, in the case where interference occurs among a plurality of RF-tag reader/writers for reading RF-tag identifiers of RF-tags, controls a schedule for the plurality of RF-tag reader/writers includes a reading-test implementation device for implementing a test of sequential reading, through the plurality of RF-tag reader/writers, of the RF-tag identifiers of reference RF-tags that are preliminarily installed prior to operation and an ascertainment device for ascertaining whether or not a single RF-tag can be read by the plurality of RF-tag reader/writers, based on the test of reading.

An RF (Radio Frequency)-tag reader/writer interference avoidance method, according to the present invention, utilized in an RF-tag reading system including an RF-tag reader/writer control system that, in the case where interference occurs among a plurality of RF-tag reader/writers for reading RF-tag identifiers of RF-tags, controls a schedule for the plurality of RF-tag reader/writers makes a computer implement a reading-test implementation process of making the RF-tag reader/writer control system implement a test of sequential reading, through the plurality of RF-tag reader/writers, of the RF-tag identifiers of reference RF-tags that are preliminarily installed prior to operation and an ascertainment process of ascertaining whether or not a single RF-tag can be read by the plurality of RF-tag reader/writers, based on the test of reading.

A program of an RF (Radio Frequency)-tag reader/writer interference avoidance method, according to the present invention, utilized in an RF-tag reading system including an RF-tag reader/writer control system that, in the case where interference occurs among a plurality of RF-tag reader/writers for reading RF-tag identifiers of RF-tags, controls a schedule for the plurality of RF-tag reader/writers makes a computer implement the processes of implementing a test of sequential reading, through the plurality of RF-tag reader/writers, of the RF-tag identifiers of reference RF-tags that are preliminarily installed prior to operation and ascertaining whether or not a single RF-tag can be read by the plurality of RF-tag reader/writers, based on the test of reading.

In other words, RF (Radio Frequency)-tag reading systems, according to the present invention, is characterized in that, in the case where interference occurs among a plurality of RF-tag reader/writers for reading the RF-tag IDs of RF-tags, provides a method of automatically controlling a schedule for the RF-tag reader/writers.

In an RF-tag reading system according to the present invention, by installing reference RF-tags prior to operation and implementing a test of sequential reading through RF-tag reader/writers, whether or not a single RF-tag is read by a plurality of RF-tag reader/writers is ascertained.

In the case where the single RF-tag can be read by the respective plurality of RF-tag reader/writers, interference occurs among respective query signals from the plurality of RF-tag reader/writers; therefore, control of a reading-timing schedule for the respective plurality of RF-tag reader/writers is implemented. Accordingly, in an RF-tag reading system according to the present invention, it is possible to automatically determine whether or not interference among a plurality of RF-tag reader/writers occurs; therefore, costs for installation of RF-tag reader/writers can be reduced.

As described heretofore, in an RF-tag reading system according to the present invention, even in the case where a plurality of RF-tag reader/writers exist, it is possible to automatically create a reading schedule for the respective plurality of RF-tag reader/writers to read RF-tag IDs, without interfering with one another; therefore, costs for installation of RF-tag reader/writers can be reduced, and the schedule can readily be created again, even though change or addition occurs in the installation condition of the RF-tag reader/writers.

### BRIEF DESCRIPTION OF THE DRAWINGS

FIG. 1 is a block diagram illustrating the configuration of an RF-tag reading system according to a first embodiment of the present invention;

FIG. 2 is a flowchart illustrating the creation operation, of a schedule table, by a schedule creation unit in FIG. 1;

FIG. 3 is a table representing an example of a configuration of the schedule table that is created by the schedule creation unit in FIG. 1;

FIG. 4 is a flowchart illustrating reading processing by a schedule control unit in FIG. 1;

FIG. 5 is a block diagram illustrating the configuration of an RF-tag reading system according to a second embodiment of the present invention;

FIG. 6 is a flowchart illustrating the creation operation, of a schedule table, by a schedule creation unit in FIG. 5;

FIG. 7 is a flowchart illustrating table-conversion processing by the schedule creation unit in FIG. 5;

FIG. 8A is a table representing an example of a configuration of an RF-tag table that is created by the schedule creation unit in FIG. 5;

FIG. 8B is a table representing an example of a configuration of the schedule table that is created by the schedule creation unit in FIG. 5; and

FIG. 9 is a flowchart illustrating reading processing by a schedule control unit in FIG. 5.

### DETAILED DESCRIPTION OF THE PREFERRED EMBODIMENTS

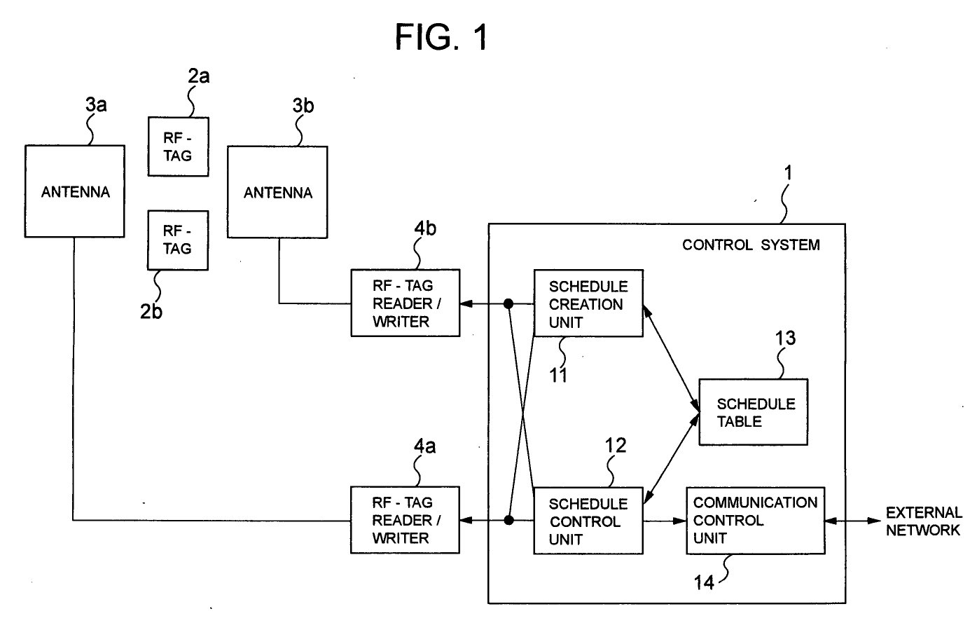

Embodiments of the present invention will be explained below with reference to the drawings. FIG. 1 is a block diagram illustrating the configuration of an RF (Radio Frequency)-tag reading system according to a first embodiment of the present invention. In FIG. 1, the RF-tag reading system according to the first embodiment of the present invention is configured of RF-tags 2a and 2b as reference for reading, antennas 3a and 3b for implementing wireless communication with the RF-tags 2a and 2b, RF-tag reader/writers 4a and 4b for controlling signals for the antennas 3a and 3b, and a control system 1 for controlling the RF-tag reader/writers 4a and 4b.

The RF-tag reader/writers 4a and 4b control the antennas 3a and 3b to read the IDs (Identifiers: identification information) of the RF-tags 2a and 2b and to start or stop outputting of RF signals.

The control system 1 is configured of a schedule creation unit 11, a schedule control unit 12, a schedule table 13, and a communication control unit 14 for implementing communication with an unillustrated external network. The schedule table 13 is a table that stores the identifiers of the RF-tag reader/writers 4a and 4b to which schedule control should be applied. In addition, fields for storing the IDs of the RF-tags 2a and 2b are incorporated in the schedule table 13 and utilized during creation of the schedule table 13.

The schedule creation unit 11 controls the RF-tag reader/writers 4a and 4b to detect interference and writes a reading schedule in the schedule table 13. The schedule control unit 12 reads RF-tag information from the RF-tag reader/writers 4a and 4b, while controlling timing in accordance with the contents of the schedule table 13. The communication control unit 14 sends to an application and the like in the external network the RF-tag information read out from the RF-tag reader/writers 4a and 4b, in accordance with the timing control by the schedule control unit 12.

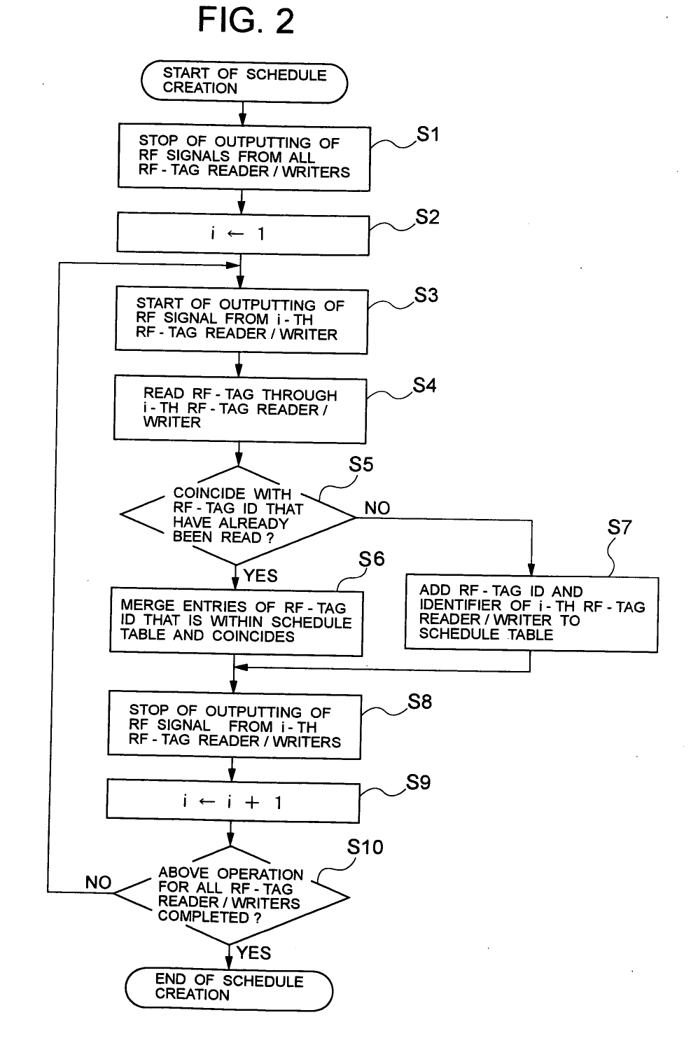

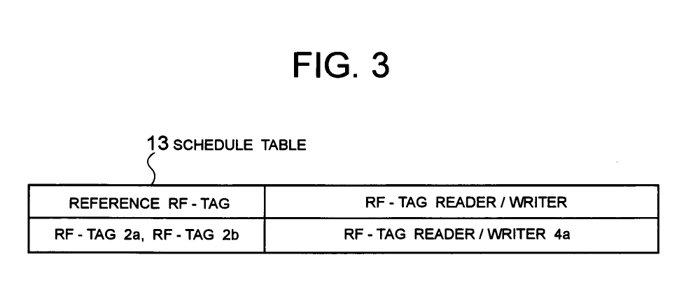

FIG. 2 is a flowchart illustrating the creation operation, of the schedule table 13, by the schedule creation unit 11 in FIG. 1; FIG. 3 is a table representing an example of a configuration of the schedule table 13 that is created by the schedule creation unit 11 in FIG. 1. The creation operation for the schedule table 13 according to the first embodiment of the present invention will be explained with reference to FIGS. 1 to 3. In addition, in the case where the control system 1 is configured of an unillustrated CPU (central processing unit) and a main memory, the CPU achieves processing operation represented in FIG. 2, by implementing a program in the main memory.

When the schedule table 13 is created, the RF-tags 2a and 2b as reference RF-tags are arranged in the vicinities of the RF-tag reader/writers 4a and 4b, respectively. The schedule creation unit 11 issues the RF-output-stop request to the RF-tag reader/writers 4a and 4b (the step S1 in FIG. 2). According to the request, the RF-tag reader/writers 4a and 4b stop outputting of RF signals from the antennas 3a and 3b.

Next, the control system 1 ascertains RF-tags 2a and/or 2b that can be read by the RF-tag reader/writers 4a or 4b. In this case, the schedule creation unit 11 issues to the RF-tag reader/writer 4a the RF-output-start request (the steps S2 and S3 in FIG. 2). According to the request, the RF-tag reader/writer 4a starts outputting of the RF signal from the antenna 3a.

Subsequently, the schedule creation unit 11 issues to the RF-tag reader/writer 4a the read request (the step S4 in FIG. 2). In this situation, the antennas (in the case of FIG. 1, the antenna 3b) other than the antenna 3a have stopped outputting of the RF signals; therefore, the RF-tags 2a and 2b in the vicinity of the antenna 3a can be read in the absence of interference.

Because no entry exists in the schedule table 13, the schedule creation unit 11 adds a new entry to the schedule table 13 (the step S7 in FIG. 2). For example, both the RF-tags 2a and 2b can be read, the schedule table 13 stores an entry that includes the IDs of the RF-tags 2a and 2b in the reference RF-tag field and the ID of the RF-tag reader/writer 4a in the RF-tag reader/writer field. Accordingly, it can be seen that the RF-tags 2a and 2b exist within the reading coverage of the RF-tag reader/writer 4a. At this stage, the contents of the schedule table 13 are as represented in FIG. 3.

Because the RF-tag reader/writer 4a has completed its reading operation, the schedule creation unit 11 issues to the RF-tag reader/writer 4a the RF-output-stop request (the step S8 in FIG. 2).

As is the case with the foregoing processing for the RF-tag reader/writer 4a, the schedule creation unit 11 ascertains RF-tags 2a and/or 2b that can be read by the RF-tag reader/writer 4b. The schedule creation unit 11 issues to the RF-tag reader/writer 4b the RF-output-start request (the steps S9, S10, and S3 in FIG. 2) and then implements reading of the RF-tags (the step S4 in FIG. 2).

If the same RF-tag as the RF-tag that has been read previously is read, the schedule creation unit 11 applies merge processing to the entries in the schedule table 13 (the step S6 in FIG. 2). In the merge processing, with regard to the reference RF-tag fields and the RF-tag reader/writer fields for all entries including the read RF-tag ID, respective unions are made, and the previous entries are replaced by the unions as a new entry.

Next, the schedule creation unit 11 adds to the reference RF-tag field for the new entry the RF-tag ID that has currently been read and adds to the RF-tag reader/writer field for the new entry the ID of the RF-tag reader/writer 4b that has currently read the RF-tag ID. For instance, if only the RF-tag 2b has been read, the merge processing is implemented because the schedule table 13 includes the RF-tag 2b as shown in FIG. 3. Because only one entry includes the RF-tag 2b, the contents of the entry do not change even though the merge processing is applied. Because the same RF-tag ID as the RF-tag 2b that has currently been read is already stored in the entry, the reference RF-tag field is not updated; the ID of the RF-tag reader/writer 4b is added to the RF-tag reader/writer field.

Now that the processing for each RF-tag reader/writer has been completed, the schedule creation unit 11 ends the schedule-creation processing (the steps S9 and S10 in FIG. 2). Through the procedure heretofore, the RF-tag reader/writers that may interfere with each other are stored in the same entry in the schedule table 13.

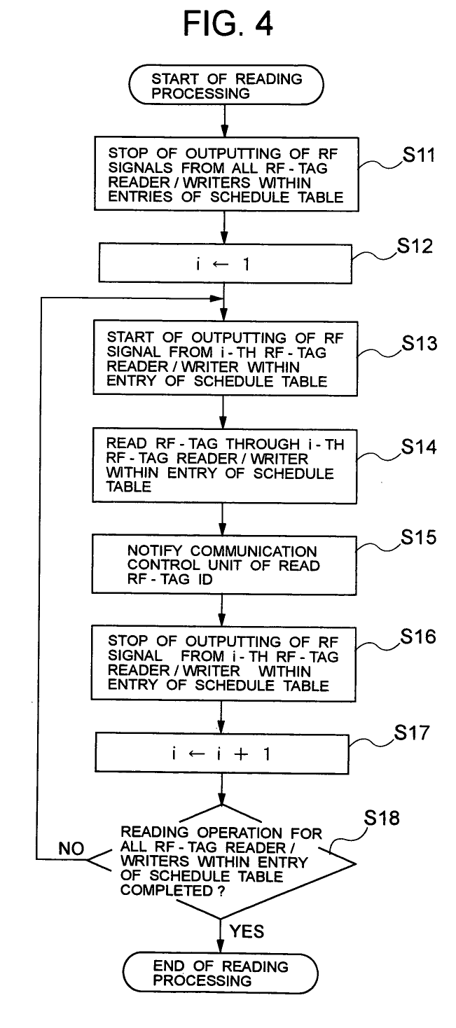

FIG. 4 is a flowchart illustrating the reading processing of the schedule control unit 12 in FIG. 1. Reading processing according to the first embodiment of the present invention will be explained with reference to FIGS. 1, 3, and 4. In addition, the foregoing CPU achieves processing operation illustrated in FIG. 4, by implementing a program in the main memory. A procedure will be explained below in which, by utilizing the created schedule table 13, reading is implemented in such a way as not to cause the interference. In this situation, the RF-tags 2a and 2b that have been utilized as the reference RF-tags in the creation operation for the schedule table 13 may be removed.

The schedule control unit 12 implements reading control for each entry in the schedule table 13, in accordance with a procedure below. Parallel reading control can be applied to different entries. In the first place, the schedule control unit 12 issues the RF-output-stop request to all RF-tag reader/writers stored in the RF-tag reader/writer fields of the entries in the schedule table 13 (the step S11 in FIG. 4).

Subsequently, the schedule control unit 12 implements reading processing for RF-tag reader/writers in the entry in the schedule table 13, in accordance with a procedure below. The schedule control unit 12 issues the RF-output-start request to the RF-tag reader/writer 4a that is the first RF-tag reader/writer stored in the entry in the schedule table 13 (the steps S12 and S13 in FIG. 4).

Thereafter, the schedule control unit 12 issues the RF-tag reading request to the RF-tag reader/writer 4a (the step S14 in FIG. 4). The schedule control unit 12 notifies the communication control unit 14 of the read RF-tag ID (the step S15 in FIG. 4). The communication control unit 14 notifies an application and the like of the RF-tag information, by way of an external network. Now that the processing for the RF-tag reader/writer 4a has been completed, the schedule control unit 12 issues the RF-output-stop request to the RF-tag reader/writer 4a (the step S16 in FIG. 4).

Next, as is the case with the foregoing processing for the RF-tag reader/writer 4a, the schedule control unit 12 applies the RF-tag reading processing also to the RF-tag reader/writer 4b that is the second RF-tag reader/writer in the entry of the schedule table 13.

The schedule control unit 12 issues the RF-output-start request to the RF-tag reader/writer 4b (the steps S17, S18, and S13 in FIG. 4) and the RF-tag reading request (the step S14 in FIG. 4). The schedule control unit 12 notifies the application and the like of the read RF-tag ID, by way of the communication control unit 14 (the step S15 in FIG. 4). The schedule control unit 12 stops outputting, of the RF signal, by the RF-tag reader/writer 4b (the step S16 in FIG. 4). Now that the processing for each RF-tag reader/writer in the entry in the schedule table 13 has been completed, the schedule control unit 12 ends the reading processing for the entry (the steps S17 and S18 in FIG. 4).

The schedule control unit 12 performs repeatedly the foregoing procedure for each entry in the schedule table 13. Therefore, the RF-tag reader/writers 4a and 4b can read RF-tags, while avoiding interference between the query signals from the RF-tag reader/writers 4a and 4b.

According to the present embodiment, even in the case where a plurality of RF-tag reader/writers 4a and 4b exist, it is possible to automatically create a reading schedule for reading RF-tags, without mutual interference. Accordingly, in the present embodiment, costs for installation of RF-tag reader/writers can be reduced; additionally, in the present embodiment, the schedule can readily be created again, even though change or addition occurs in the installation condition of RF-tag reader/writers.

In the present embodiment, a case has been explained in which two RF-tag reader/writers exist; however, the number of RF-tag reader/writers is not limited. Moreover, in the present embodiment, a case has been explained in which one reference RF-tag is installed for each RF-tag reader/writer; however, two or more reference RF-tags may be installed for each RF-tag reader/writer.

Still moreover, in the present embodiment, a case has been explained in which an application that actually processes RF-tag information exists in an external network; however, the application may exist in the same apparatus as that in which the control system 1 is incorporated, or may be connected to the control system 1, in other ways.

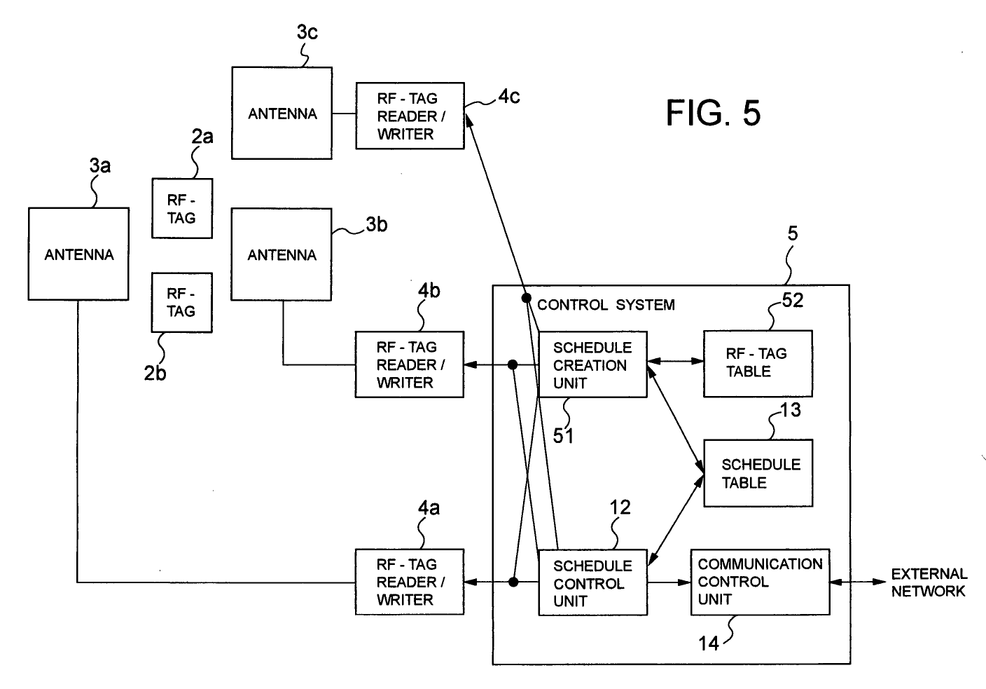

FIG. 5 is a block diagram illustrating the configuration of an RF-tag reading system according to a second embodiment of the present invention. In FIG. 5, the RF-tag reading system according to the second embodiment of the present invention is configured in the same way in which the RF-tag reading system, illustrated in FIG. 1, according to the first embodiment of the present invention is configured, except that an RF-tag table 52 is provided in a control system 5, and the schedule creation unit 11 is replaced by a schedule creation unit 51 that creates a schedule by utilizing the RF-tag table 52; like reference characters denote like constituent elements.

The identifier of an RF-tag reader/writer and the corresponding RF-tag ID read by the RF-tag reader/writer are stored in the RF-tag table 52 that is utilized by the schedule creation unit 51 when the schedule table 13 is created; in each entry of the schedule table 13, a list of the identifiers of RF-tag reader/writers that can concurrently read is stored. Moreover, in the RF-tag reading system according to the second embodiment of the present invention, an RF-tag reader/writer 4c is added.

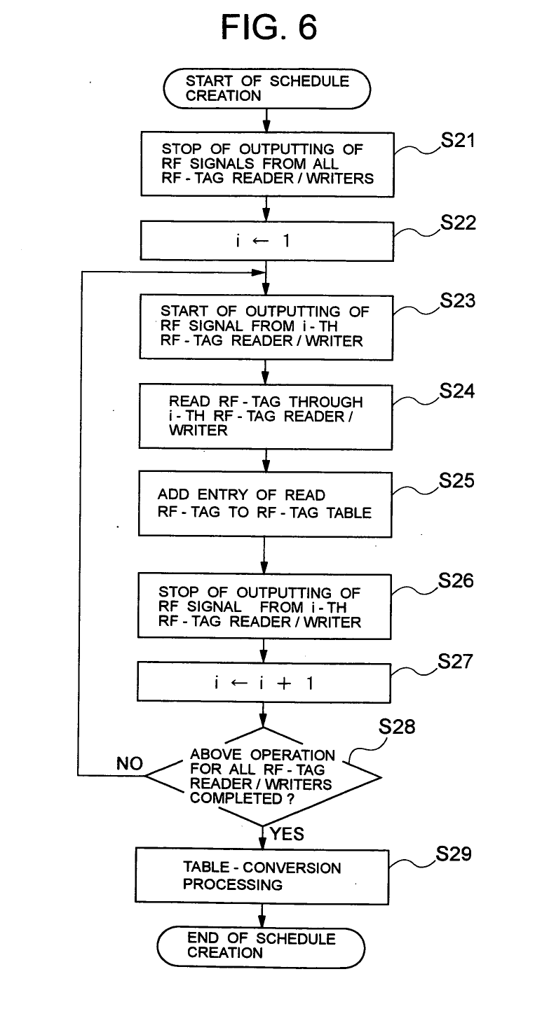

FIG. 6 is a flowchart illustrating the creation operation, of the schedule table 13, by the schedule creation unit 51 in FIG. 5. The creation operation for the schedule table 13 according to the second embodiment of the present invention will be explained with reference to FIGS. 5 and 6. In addition, in the case where the control system 5 is configured of an unillustrated CPU (central processing unit) and a main memory, the CPU achieves processing operation represented in FIG. 6, by implementing a program in the main memory.

When the schedule table 13 is created, the RF-tags 2a and 2b as reference RF-tags are arranged in the vicinities of the RF-tag reader/writers 4a, 4b, and 4c. The schedule creation unit 51 issues the RF-output-stop request to the RF-tag reader/writers 4a, 4b, and 4c (the step S21 in FIG. 6). According to the request, the RF-tag reader/writers 4a, 4b, and 4c stop outputting of RF signals from the antennas 3a, 3b and 3c.

Next, the control system 5 ascertains RF-tags 2a and/or 2b that can be read by the RF-tag readers/writers 4a, 4b, or 4c. In this case, the schedule creation unit 51 issues the RF-output-start request to the RF-tag reader/writer 4a (the steps S22 and S23 in FIG. 6). According to the request, the RF-tag reader/writer 4a starts outputting of the RF signal from the antenna 3a.

Subsequently, the schedule creation unit 51 issues the read request to the RF-tag reader/writer 4a (the step S24 in FIG. 6). In this situation, the antennas (in the case of FIG. 5, the antennas 3b and 3c) other than the antenna 3a have stopped outputting of the RF signals; therefore, the RF-tags 2a and 2b in the vicinity of the antenna 3a can be read without interference.

After reading the RF-tags 2a and 2b, the schedule creation unit 51 writes in the RF-tag table 52 a list of the read RF-tags 2a and 2b (the step S25 in FIG. 6). Because the RF-tag reader/writer 4a has completed its reading operation, the schedule creation unit 51 issues the RF-output-stop request to the RF-tag reader/writer 4a (the step S26 in FIG. 6).

As is the case with the foregoing processing for the RF-tag reader/writer 4a, the schedule creation unit 51 ascertains RF-tags 2a and/or 2b that can be read by the RF-tag reader/writer 4b. The schedule creation unit 51 issues to the RF-tag reader/writer 4b the RF-output-start request (the steps S27, S28, and S23 in FIG. 6) and then implements reading of the RF-tags (the step S24 in FIG. 6).

After reading the RF-tags 2a and 2b, the schedule creation unit 51 writes in the RF-tag table 52 a list of the read RF-tags 2a and 2b (the step S25 in FIG. 6). Because the RF-tag reader/writer 4b has completed its reading operation, the schedule creation unit 51 issues the RF-output-stop request to the RF-tag reader/writer 4b (the step S26 in FIG. 6).

As is the case with the foregoing processing for each of the RF-tag reader/writers 4a and 4b, the schedule creation unit 51 ascertains RF-tags 2a and/or 2b that can be read by the RF-tag reader/writer 4c. The schedule creation unit 51 issues the RF-output-start request to the RF-tag reader/writer 4c (the steps S27, S28, and S23 in FIG. 6) and then implements reading of the RF-tags (the step S24 in FIG. 2).

After reading the RF-tags 2a and 2b, the schedule creation unit 51 writes in the RF-tag table 52 a list of the read RF-tags 2a and 2b (the step S25 in FIG. 6). Because the RF-tag reader/writer 4c has completed its reading operation, the schedule creation unit 51 issues the RF-output-stop request to the RF-tag reader/writer 4c (the step S26 in FIG. 6).

After all the RF-tag reader/writers 4a, 4b, and 4c have completed their reading operation (the steps S27 and S28 in FIG. 6), the schedule creation unit 51 implements table-conversion processing for creating the schedule table 13, with reference to the RF-tag table 52 (the step S29 in FIG. 6).

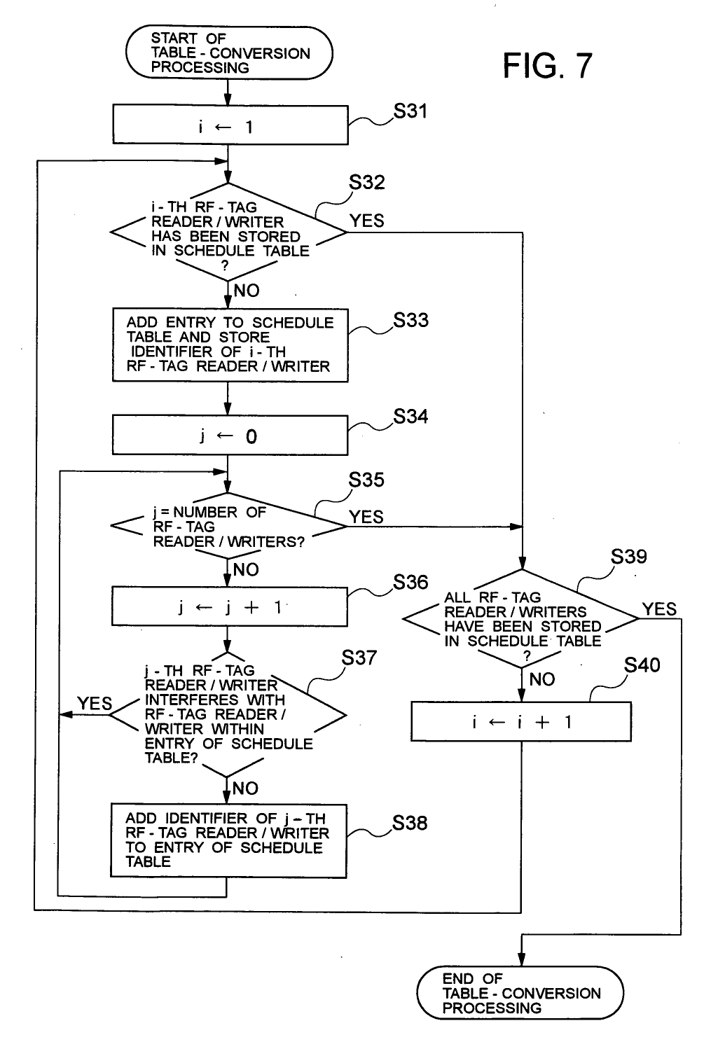

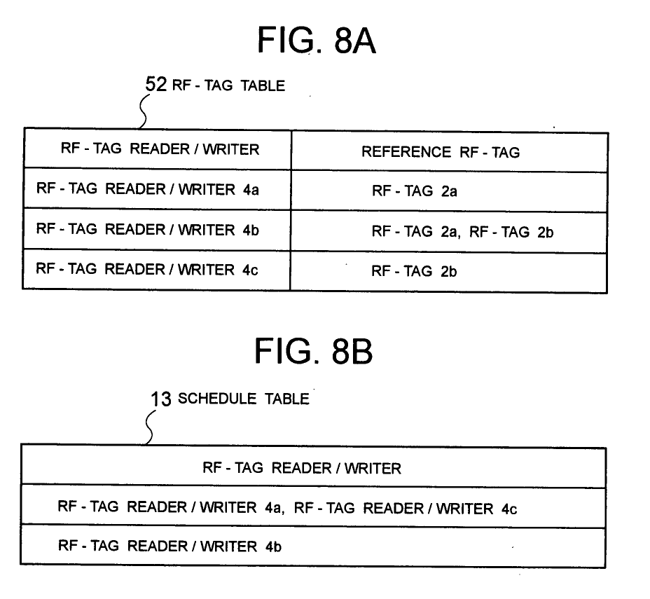

FIG. 7 is a flowchart illustrating the table-conversion processing by the schedule creation unit 51 in FIG. 5; FIG. 8A is a table representing an example of a configuration of the RF-tag table 52 that is created by the schedule creation unit 51 in FIG. 5; and FIG. 8B is a table representing an example of a configuration of the schedule table 13 that is created by the schedule creation unit 51 in FIG. 5. The table-conversion processing according to the second embodiment of the present invention will be explained with reference to FIGS. 5, 7, and 8. In addition, the foregoing CPU achieves processing operation illustrated in FIG. 7, by implementing a program in the main memory.

In the first place, the schedule creation unit 51 refers to the first entry of the RF-tag table 52 and then stores in an new entry of the schedule table 13 the identifier of the RF-tag reader/writer of the first entry of the RF-tag table 52 (the steps S31 to S33 in FIG. 7). The schedule creation unit 51 checks other entries of the RF-tag table 52 (the steps S34 to S37 in FIG. 7) and then adds to the new entry of the schedule table 13 the identifiers of the RF-tag reader/writers that do not interfere with RF-tag reader/writer of the first entry (the step S38 in FIG. 7).

For example, in the case where the RF-tag table 52 as represented in FIG. 8A exists, because the first entry of the RF-tag table 52 is the RF-tag reader/writer 4a, the RF-tag reader/writer 4a is stored in the first entry of the schedule table 13 (the step S33 in FIG. 7).

The second entry of the RF-tag table 52 is the RF-tag reader/writer 4b; however, because, with regard to the RF-tag 2a, interfering with the RF-tag reader/writer 4a, the RF-tag reader/writer 4b is not added to the first entry of the schedule table 13. The last entry of the RF-tag table 52 is the RF-tag reader/writer 4c; because, with regard to the RF-tag 2b, not interfering with the RF-tag reader/writer 4a, the RF-tag reader/writer 4c is added to the first entry of the schedule table 13 (the step S38 in FIG. 7). As a result, the first entry of the schedule table 13 consists of the RF-tag reader/writers 4a and 4c.

By applying similar processing also to each of the RF-tag reader/writers, among the remaining entries of the RF-tag table 52, that have not yet been stored in the schedule table 13, the schedule table 13 is created. In the example represented in FIGS. 8A and 8B, the RF-tag reader/writer 4b of the second entry of the RF-tag table 52 is stored in the second entry of the schedule table 13. Because the RF-tag reader/writer 4b interferes with other RF-tag reader/writers, the second entry of the schedule table 13 consists of the RF-tag reader/writer 4b only. When all the RF-tag reader/writers are registered in the schedule table 13, the creation of the schedule table 13 is completed (the step S39 in FIG. 7).

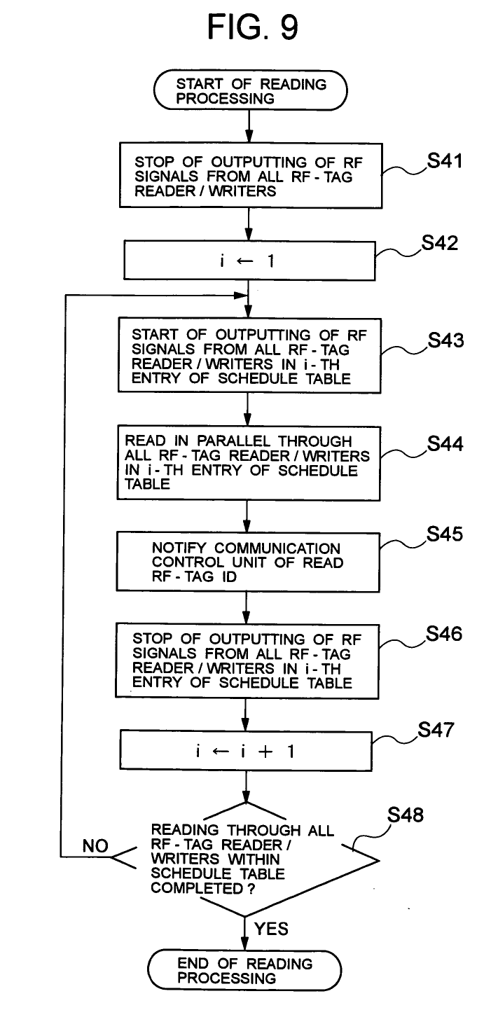

FIG. 9 is a flowchart illustrating the reading processing of the schedule control unit 12 in FIG. 5. The reading processing according to the second embodiment of the present invention will be explained with reference to FIGS. 5, 8, and 9. In addition, the foregoing CPU achieves processing operation illustrated in FIG. 9, by implementing a program in the main memory.

In the first place, the schedule control unit 12 stops outputting, of the RF signals, by all the RF-tag reader/writers 4a, 4b, and 4c (the step S41 in FIG. 9). Thereafter, the schedule control unit 12 refers to the first entry of the schedule table 13, starts outputting, of the RF signals, by all the RF-tag reader/writers that are stored in the first entry (the steps S42 and 43 in FIG. 9), and implements parallel reading processing (the step S44 in FIG. 9). The schedule control unit 12 notifies the communication control unit 14 of the read RF-tag IDs (the step S45 in FIG. 9) and then stops outputting, of RF signals, by all the RF-tag reader/writers that are stored in the first entry (the step S46 in FIG. 9). The schedule control unit 12 applies processing similar to that described above to each of the remaining entries of the schedule table 13, thereby implementing the reading processing (the steps S43 to S48 in FIG. 9).

According to the second embodiment, with regard to a group of RF-tag reader/writers, in the case where, even though concurrent reading processing by all the RF-tag reader/writers causes interference, several combinations among the group enable concurrent reading processing, efficient reading processing can be implemented.

What is claimed is:

1. An RF (Radio Frequency)-tag reading system including an RF-tag reader/writer control system that, in the case where interference occurs among a plurality of RF-tag reader/writers for reading RF-tag identifiers of RF-tags, controls a schedule for the plurality of RF-tag reader/writers, the RF-tag reader/writer control system comprising:
reading-test implementation means of implementing a test of sequential reading, through the plurality of RF-tag reader/writers, of the RF-tag identifiers of reference RF-tags that are preliminarily installed prior to operation; and
ascertainment means of ascertaining whether or not a single RF-tag can be read by the plurality of RF-tag reader/writers, based on the test of reading.

2. The RF-tag reading system according to claim 1, wherein, in the case where the single RF-tag can be read by the plurality of RF-tag reader/writers, the RF-tag reader/writer control system determines that interference occurs among respective query signals from the plurality of RF-tag reader/writers and then implements control of a reading-timing schedule for the respective plurality of RF-tag reader/writers.

3. The RF-tag reading system according to claim 1, wherein the RF-tag reader/writer control system includes a schedule table in which identifiers of the RF-tag reader/writers to which the control of a reading-timing schedule has to be applied and RF-tag identifiers of the reference RF-tags are stored, the schedule table being created based on the RF-tag identifiers of the reference RF-tags.

4. The RF-tag reading system according to claim 1, wherein the RF-tag reader/writer control system includes an RF-tag table in which correspondence between the identifier of the RF-tag reader/writer and the RF-tag identifier read by the RF-tag reader/writer are stored and a schedule table in each entry of which a list of the identifiers of the RF-tag reader/writers that can concurrently read is stored, the schedule table being created by utilizing the RF-tag table.

5. An RF (Radio Frequency)-tag reader/writer control system that, in the case where interference occurs among a plurality of RF-tag reader/writers for reading RF-tag identifiers of RF-tags, controls a schedule for the plurality of RF-tag reader/writers, the RF-tag reader/writer control system comprising:
reading-test implementation means of implementing a test of sequential reading, through the plurality of RF-tag reader/writers, of the RF-tag identifiers of reference RF-tags that are preliminarily installed prior to operation; and
ascertainment means of ascertaining whether or not a single RF-tag can be read by the plurality of RF-tag reader/writers, based on the test of reading.

6. The RF-tag reader/writer control system according to claim 5, wherein, in the case where the single RF-tag can be read by the plurality of RF-tag reader/writers, the RF-tag reader/writer control system determines that interference occurs among respective query signals from the plurality of RF-tag reader/writers and then implements control of a reading-timing schedule for the respective plurality of RF-tag reader/writers.

7. The RF-tag reader/writer control system according to claim 5, wherein the RF-tag reader/writer control system includes a schedule table in which identifiers of the RF-tag reader/writers to which the control of a reading-timing schedule has to be applied and RF-tag identifiers of the reference RF-tags are stored, the schedule table being created based on the RF-tag identifiers of the reference RF-tags.

8. The RF-tag reader/writer control system according to claim 5, wherein the RF-tag reader/writer control system includes an RF-tag table in which correspondence between the identifier of the RF-tag reader/writer and the RF-tag identifier read by the RF-tag reader/writer are stored and a schedule table in each entry of which a list of the identifiers of the RF-tag reader/writers that can concurrently read is stored, the schedule table being created by utilizing the RF-tag table.

9. An RF (Radio Frequency)-tag reader/writer interference avoidance method utilized in an RF-tag reading system including an RF-tag reader/writer control system that, in the case where interference occurs among a plurality of RF-tag reader/writers for reading RF-tag identifiers of RF-tags, controls a schedule for the plurality of RF-tag reader/writers, the RF-tag reader/writer interference avoidance method implementing:
a reading-test implementation process of making the RF-tag reader/writer control system implement a test of sequential reading, through the plurality of RF-tag reader/writers, of the RF-tag identifiers of reference RF-tags that are preliminarily installed prior to operation; and
an ascertainment process of ascertaining whether or not a single RF-tag can be read by the plurality of RF-tag reader/writers, based on the test of reading.

10. The RF-tag reader/writer interference avoidance method according to claim 9, wherein, in the case where the single RF-tag can be read by the plurality of RF-tag reader/writers, the RF-tag reader/writer control system determines that interference occurs among respective query signals from the plurality of RF-tag reader/writers and then implements control of a reading-timing schedule for the respective plurality of RF-tag reader/writers.

11. The RF-tag reader/writer interference avoidance method according to claim 9, wherein the RF-tag reader/writer control system is provided with a schedule table in which identifiers of the RF-tag reader/writers to which the control of a reading-timing schedule has to be applied and RF-tag identifiers of the reference RF-tags are stored, and the RF-tag reader/writer control system creates the schedule table, based on the RF-tag identifiers of the reference RF-tags.

12. The RF-tag reader/writer interference avoidance method according to claim 9, wherein the RF-tag reader/writer control system is provided with an RF-tag table in which correspondence between the identifier of the RF-tag reader/writer and the RF-tag identifier read by the RF-tag reader/writer are stored and a schedule table in each entry of which a list of the identifiers of the RF-tag reader/writers that can concurrently read is stored, and the RF-tag reader/writer control system creates the schedule table, by utilizing the RF-tag table.

13. A program of an RF (Radio Frequency)-tag reader/writer interference avoidance method utilized in an RF-tag reading system including an RF-tag reader/writer control system that, in the case where interference occurs among a plurality of RF-tag reader/writers for reading RF-tag identifiers of RF-tags, controls a schedule for the plurality of RF-tag reader/writers, the program making a computer implement the processes of:
implementing a test of sequential reading, through the plurality of RF-tag reader/writers, of the RF-tag identifiers of reference RF-tags that are preliminarily installed prior to operation; and
ascertaining whether or not a single RF-tag can be read by the plurality of RF-tag reader/writers, based on the test of reading.
